(19) United States
(12) Patent Application Publication
(10) Pub. No.: US 2012/0116899 A1
(43) Pub. Date: May 10, 2012

(54) MANAGEMENT OF PROSPECTIVE CUSTOMER DATA OVER A COMMUNICATIONS NETWORK

(76) Inventor: Andrew Philip Chesler, Miami Beach, FL (US)

(21) Appl. No.: 12/942,059

(22) Filed: Nov. 9, 2010

(51) Int. Cl. G06Q 30/00

(52) U.S. Cl. 705/16

(57) ABSTRACT

A method and computer system for managing prospective customer data in a central repository over a communications network is disclosed. The method includes receiving profile data from a prospective customer, storing the profile data in a central data repository, displaying the profile data for viewing by a representative, wherein selected profile data is highlighted for use by the representative in selling to the prospective customer, generating a schedule of actions pertaining to the prospective customer based on the profile data, wherein an action includes sending a communication to the prospective customer, transmitting one or more communications to the prospective customer based on the schedule of actions, receiving updates regarding results of the communications transmitted to the prospective customer and augmenting the profile data of the prospective customer in the central repository with the results of the communications transmitted to the prospective customer.

### BACKGROUND OF THE INVENTION

1. Field of the Invention

The present invention relates to the field of customer relationship management and, more specifically, the present invention relates to the field of management of prospective customer data over a communications network.

2. Description of the Related Art

There is a general sentiment that the quality and level of customer service has decreased in recent years. To address this concern, many business organizations have employed a variety of methods to improve their customer satisfaction levels. One advancement in this respect is the emergence of software for managing customer relationships, i.e., CRM (customer relationship management) software. Due to its effectiveness, CRM software is a multi-billion dollar business in the U.S. alone.

CRM software facilitates a company's strategy for managing its interactions with customers by organizing, automating, and synchronizing business processes such as sales activities, marketing, customer service, and technical support. CRM software generally aids a company in nurturing and retaining its customers, enticing former customers back into the fold, and reducing the costs of marketing and client service. Due to its scalability, CRM software is highly popular with businesses that serve large numbers of customers, such as banks, telecommunications providers and insurance companies.

On a day-to-day basis, CRM software is generally used to log and direct a company's interactions with its customers. When a company representative calls a customer, for example, the results of the call and the services provided to the customer are logged for future recall. Likewise, when a company receives an order and delivers a product to a customer, the action is recorded. Based on all such information that is stored about a customer, a company can decide how and when to market or advertise to that customer. Additionally, when the company communicates with the customer in the future, the CRM software can recall the previously recorded information pertaining to that customer so that it may be used during the communication.

One of the shortcomings of conventional CRM software, however, is that it focuses on existing customer relationships. In other words, conventional CRM software assumes that a customer relationship already exists and must be managed. There are few, if any, CRM software solutions for managing prospective customer relationships. This is a major drawback for businesses that encounter large amounts of prospective customers. Health clubs and spas, for example, traditionally have a large number of individuals that visit the establishment in order to inquire about its services. Currently available CRM software, however, does not offer an adequate way to manage the contact information of these prospective customers.

Therefore, what is needed is a system and method for improving the problems with the prior art, and more particularly for a more efficient method and system for managing prospective customer relationships over a communications network.

### BRIEF SUMMARY OF THE INVENTION

Embodiments of the present invention address deficiencies of the art in respect to management of prospective customer data and provide a novel and non-obvious method, server and computer program product for managing prospective customer data in a central repository over a communications network. In an embodiment of the invention, the steps performed by the method and computer system of the present invention include receiving profile data from a prospective customer at a first terminal at a point-of-sale location, storing the profile data in a central data repository, displaying the profile data on a second terminal at the point-of-sale location for viewing by a representative, wherein selected profile data is highlighted for use by the representative in selling to the prospective customer, generating a schedule of actions pertaining to the prospective customer based on the profile data, wherein an action includes sending a communication to the prospective customer, transmitting one or more communications to the prospective customer based on the schedule of actions, receiving updates regarding results of the communications transmitted to the prospective customer and augmenting the profile data of the prospective customer in the central repository with the results of the communications transmitted to the prospective customer.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a block diagram illustrating a network architecture of a system for managing prospective customer data over a communications network, in accordance with one embodiment of the present invention.

FIG. 2 is a flow chart describing the control flow of the process for establishing a prospective customer communication process with a server over a communications network, in accordance with one embodiment of the present invention.

FIG. 3 is a flow chart describing the control flow of the process for managing communications with a prospective customer over a communications network, in accordance with one embodiment of the present invention.

### DETAILED DESCRIPTION OF THE INVENTION

The present invention improves upon the problems with the prior art by providing a more effective and efficient method and computer system for managing prospective customer data over a communications network such as the Internet. The present invention improves over the prior art by providing a central data repository for prospective customer data and by providing a schedule of communications with the prospective customer over a period of time. These features enhance a company's ability to create and execute a marketing plan focused on prospective customers, as opposed to existing customers. As communications with the prospective customer are executed, the prospective customer data is updated to reflect the results of the communications. This further enhances a company's ability to market to prospective customers as it allows the company to monitor the effectiveness of certain marketing efforts and modify them accordingly.

The present invention additionally allows a prospective customer to enter customer data and immediately displays it for a sales representative at the same location. The real time sales information is provided to a sales representative for the purpose of engaging in a sales procedure with the prospective customer. The present invention improves over the prior art by further highlighting prospective customer data that is highly relevant to executing a sale of the company's products or services. This feature is beneficial as it instantly provides a sales representative with key sales data, thereby allowing him or her to immediately use the data in a sales pitch to the prospective customer. This feature is further beneficial as it provides real time updates to the representatives of the company seeking to engage the prospective customer, thereby providing them with up-to-the-minute information that allows for more focused and more immediate sales actions.

Additionally, the present invention improves over the prior art by managing a schedule of communications with the prospective customer, wherein communications can include email, automated telephone calls, telephone calls with a live representative, and text messages. This feature is advantageous as it provides for a wide range of popular communications methods with customers and allows for central management of the same. The present invention is further highly scalable and supports complex communications types.

The present invention additionally improves over the prior art by providing a central data repository that removes the need for paper, thereby reducing space requirements, paper supply needs, and the inaccuracy associated with printed information and handwriting. By eliminating the use of handwritten documents for storing and relaying prospective customer data, as done conventionally, the present invention reduces the work burden of employees that typically manage such handwritten documents and decreases the incidence of inaccurate customer data due to human transcription.

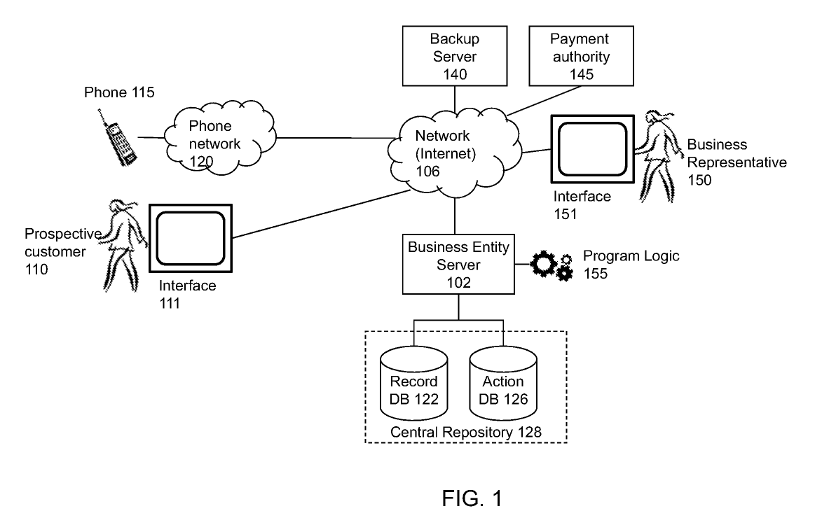

Referring now to the drawing figures in which like reference designators refer to like elements, there is shown in FIG. 1 a block diagram illustrating a network architecture of a system for managing prospective customer data over a communications network, in accordance with one embodiment of the present invention. FIG. 1 shows an embodiment of the present invention wherein prospective customer 110 and business representative 150, each using an interface, interact with server 102 (representing a business entity) over a network 106, which can be a packet switched network such as a LAN, a WAN, a PAN, the Internet, or the World Wide Web. The interfaces 111, 151 can be a desktop, a laptop, handheld computer, a smart phone, a tablet computer, interactive kiosk, a touch screen device or the like. Further, interfaces 111 and 151 may both be located in the same point of sale location or vicinity.

FIG. 1 further shows a mobile phone 115 (belonging to customer 110) connected to a phone network 120, which may be the public switched telephone system or a cellular phone system, via a wired or wireless connection. A voice over Internet Protocol (VoIP) provider (connected with the network 106) may interface with the phone network 120 to capture certain calls and voice data resulting from such calls.

Server 102, which may be a web server, is the main operative element of the present invention, executing the steps that comprise the method of the present invention. Server 102 includes a software engine that delivers applications and data content (including text files, HTML files, music files, video files, electronic book files, app files, information files, and any other media content) to users 110 and 150. Server 102 may also perform prospective customer data management tasks as described more fully below. It should be noted that although FIG. 1 shows only two users 110 and 150 and one server 102, the system of the present invention supports any number of client users and servers connected via network 106.

Server 102 includes program logic 155 comprising computer source code, scripting language code or interpreted language code that is compiled to produce computer instructions that perform various functions of the present invention. In one embodiment of the present invention, the program logic is a scripting language such as ECMAScript, CSS, XML or Javascript. Program logic 155 may reside on a client computer, the server 102 or any combination of the two.

In one embodiment of the present invention, the network application provided by the server 102 of FIG. 1 (i.e., program logic 155) is a client-server application having a client portion that resides on client computers 111, 151 and a server application that resides on server 102. For example, the network application can be a web interface that is accessed by client computers 111, 151 via network 106. In another embodiment of the present invention, the server 120 delivers to clients 111, 151 an application having only a client portion that resides on client computers 111, 151. For example, the application can be a web browser extension or web browser add-on, which is an installable enhancement to a web browser.

FIG. 1 further shows that server 102 is connected to a prospective customer record database 122 and action database 126. Database 122 is used to store customer records, such as customer profiles and other customer account data, which have been created for each prospective customer 110. Database 126 stores all action data pertaining to each prospective customer record in database 122. Action data refers to all actions or sales efforts, such as sales-related communications, that have been undertaken for a particular prospective customer. Each action record in action database 126 is linked to a prospective customer record in database 122. Databases 122 and 126 are collectively referred to as the “data repository” or the “central repository” for all resident data served by server 102 in the present invention. Note that although FIG. 1 shows only two databases 122 and 126, the present invention supports any number of databases holding various types of data that is served by server 102.

FIG. 1 also shows a payment authority 145 to effectuate payments by prospective customer 110 for products or services of the company or business entity that operates the server 102. In one embodiment of the present invention, the payment authority 145 is a payment gateway, which is an e-commerce Application Service Provider (ASP) service that authorizes payments for individuals, e-businesses, online retailers, or traditional brick and mortar businesses. A payment gateway is the equivalent of a physical point-of-sale terminal located in most retail outlets. Payment gateways encrypt sensitive information, such as credit card numbers, to ensure that information passes securely between the customer and the merchant. A payment gateway facilitates the transfer of information between a payment portal (such as a website) and the acquiring bank, quickly and securely. When a customer orders a product or service from a payment gateway enabled merchant, the payment gateway performs a variety of tasks to process the transaction. Payment gateways accept payment via the use of credit cards, charge cards, bank cards, gift cards, account cards, etc.

FIG. 1 further shows a backup server 140 which makes copies of data on server 102 and/or its associated databases 122 and 126, so that these additional copies may be used to restore the original after a data loss event. The backup server 140 may be used to restore a state following a disaster or to restore small numbers of files after they have been accidentally deleted or corrupted.

Note that although server 102 is shown as a single and independent entity, in one embodiment of the present invention, the functions of server 102 may be integrated with the functions of another entity, such as interfaces 111, 151, entities 140 and 145 of FIG. 1. Further server 102 and its functionality, according to a preferred embodiment of the present invention, can be realized in a centralized fashion in one computer system, or in a distributed fashion where different elements are spread across several interconnected computer systems.

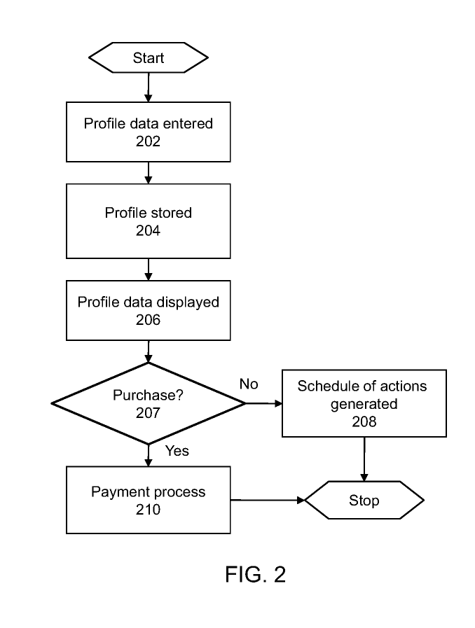

FIG. 2 is a flow chart describing the control flow of the process for establishing a prospective customer communication process with server 102 over a communications network, in accordance with one embodiment of the present invention. The flow chart of FIG. 2 describes the process undertaken when a prospective customer 110 interacts with business entity server 102 of the present invention via interface 111. The flow chart of FIG. 2 is described in association with FIG. 1.

In a first step 202, program logic 155 of server 102 provides a graphical user interface to a prospective customer 110 via interface 111 for the purpose of collecting profile data of the customer, including the user's name, address, telephone number, location, URL, email address, age, sex, preferences, employment affiliation, job description, consumer history and a list of keywords or tags associated with the user or any of the above items. In step 202, the prospective customer 110 enters the requested data in the graphical user interface provided on interface 111.

In step 204, program logic 155 of server 102 generates a profile for the prospective customer 110 based on the data garnered in step 202 and stores it in database 122 of the central repository 128. The profile may be stored in record database 122, including pointers or addresses for associated action data in database 126. The profile may also be stored in alternative locations such as client computer 151. Upon storage of the profile, the server 102 indexes the profile of the user and the associated action data based on the textual data in the profile and the action data. The indexing of the profile and associated data allows the indexed information to easily be searched and viewed by a representative 150.

In one embodiment, the profile generated in step 204 is immediately transmitted to a business representative of the business entity of server 102 via email, text message or direct data transfer, such that the business representative is kept up to date on all new or returning prospective customers. In another embodiment, the profile generated in step 204 is additionally stored in a secondary database such as backup server 140, for data redundancy purposes and for allowing additional business representatives to access the data from other remote locations.

In step 206, the data entered by the prospective customer 110 in step 202 may be instantly displayed in the interface 151 for the business representative 150 to view. In the embodiment wherein interfaces 111 and 151 are located in the same point of sale location, the business representative 150 may use the displayed information to immediately personally engage the prospective customer 110 to execute a sales pitch. The real time information provided to the business representative can increase the likelihood of success in effectuating a sale to the prospective customer 110.

Also in step 206, selected data entered by the prospective customer 110 in step 202 may be highlighted when displayed in the interface 151 for the business representative 150 to view. The selected data for highlighting may be selected based on an algorithm that identifies data relevant to selling to the prospective customer 110. Data relevant to selling to the prospective customer 110 may include the amount of time since the prospective customer has purchased the product or service being sold by the business of server 102, the goals the prospective customer seeks to achieve with the product or service, and the reason why the prospective customer has not purchased the product or service in the past. Again, the above-noted real time information provided to the business representative can streamline and shorten the sales pitch made to the prospective customer 110. In one embodiment, the highlighted data of step 206 is immediately transmitted to a business representative of the business entity of server 102 via email, text message or direct data transfer.

In step 207, program logic 155 of server 102 provides to user 110 a graphical user interface via interface 111, wherein the graphical user interface queries the user 110 whether he desires to purchase a product or service provided by the business entity of server 102. In one embodiment, the graphical user interface provides a contract for services wherein the acceptance by the user 110 of the contract constitutes an agreement to allow the business entity to automatically charge the user 110 a monthly fee on a credit or charge card provided by the user 110.

If the user 110 decides to effectuate the purchase, then in step 210, the payment process is executed. Consequently, in step 210, the prospective customer 110 may input electronic payment information (such as name, address, credit card information) into the graphical user interface of interface 111 for payment to the business of server 102 under the contract for services. Subsequently, the payment authority 145 receives the electronic payment information and credits the particular customer for such payment. In one embodiment, notice of the execution of step 210 is immediately transmitted to a business representative of the business entity of server 102 via email, text message or direct data transfer, such that the representative is instantly made aware of completed sales. If the user 110 decides not to effectuate the purchase, then step 208 is executed. Again, in one embodiment, the details of the purchase and the prospective customer 110 of step 210 are immediately transmitted to a business representative of the business entity of server 102 via email, text message or direct data transfer. In another embodiment, the details are additionally stored in a secondary database such as backup server 140, for data redundancy purposes and for allowing additional business representatives to access the data from other remote locations.

In step 208, program logic 155 of server 102 generates a schedule of actions pertaining to the prospective customer 110 based on the data he entered in step 202, wherein an action includes sending a communication to the prospective customer 110, such as an email, an automated telephone call, a telephone call with a live representative, and a text message. The communications of step 208 are marketing or advertising efforts that seek to promote the business of server 102 and representative 150. The schedule of actions may comprise a list of communications to the prospective customer 110 that shall be executed by the server 102 at later predefined dates. The schedule of actions may further comprise a list of communications to the representative 150 that shall be executed by the server 102 at later predefined dates, wherein the communications provide information about the prospective customer 110 and the results of the marketing efforts on prospective customer 110. Subsequently, the process of FIG. 2 ceases.

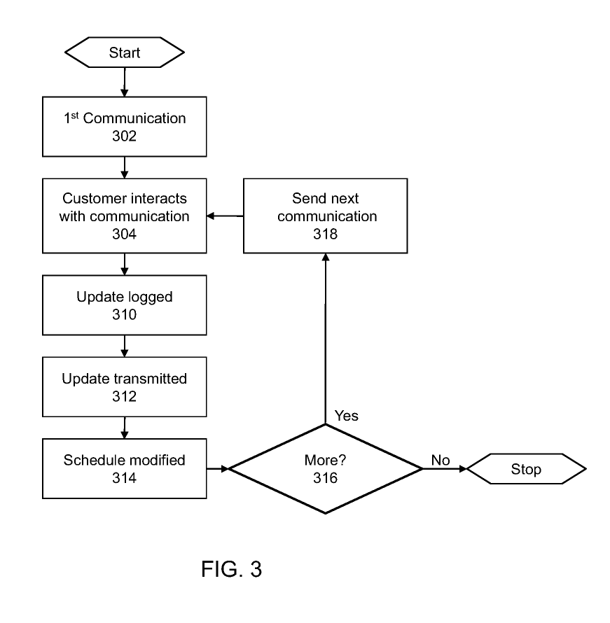

FIG. 3 is a flow chart describing the control flow of the process for managing communications with a prospective customer 110 over a communications network, in accordance with one embodiment of the present invention. The flow chart of FIG. 4 describes the process undertaken by the business of server 102 in communicating with prospective customer 110, using the system of the present invention. The flow chart of FIG. 4 is described in association with FIG. 1.

In step 302, program logic 155 of server 102 initiates a first communication with the prospective customer 110 based on the schedule of actions generated in step 208. A communication to prospective customer 110 may include an email, an automated telephone call, a telephone call with a live representative, and a text message. The communication is logged in database 126 and linked to the record of prospective customer 110 in database 122. In one embodiment, the details of the first communication are immediately transmitted to a business representative of the business entity of server 102 via email, text message or direct data transfer, such that the business representative is kept up to date on all communications to the prospective customer. In another embodiment, the details of the first communication are additionally stored in a secondary database such as backup server 140, for data redundancy purposes and for allowing additional business representatives to access the data from other remote locations.

In step 304, the prospective customer 110, or his proxy, interacts with the communication of step 302. In response to the communication, the prospective customer 110 may input electronic payment information (such as name, address, credit card information) into a graphical user interface of interface 111 or phone 115 for payment for purchase of the product or services of the business of server 102. Subsequently, the payment authority 145 receives the electronic payment information and credits the particular customer for such payment.

In one embodiment, the details of the customer's actions in step 304 are immediately transmitted to a business representative of the business entity of server 102, such that the business representative is kept up to date on all actions taken by prospective customers in response to server 102's communications. In another embodiment, the details of the customer's actions in step 304 are additionally stored in a secondary database such as backup server 140.

In step 310, business representative 150 sends to server 102 (via interface 151, for example) an update regarding the result of the communication transmitted to the prospective customer 110 in step 302. The update is logged in database 126 and linked to the record of prospective customer 110 in database 122. An update may include an indicator of the inability to communicate with the prospective customer 110 in step 302, an indicator of an unsuccessful communication with the prospective customer 110 in step 302, and an indicator of a request from the prospective customer 110 to communicate at a future time.

In step 312, the program logic 155 of server 102 sends to representative 150 the updates logged in step 310. The updates of step 312 may be transmitted via email, text message or the like. In step 314, the schedule of actions is modified based on the updates logged in step 310. For example, if the results of previous communications indicate that the prospective customer is not reachable by phone, the schedule of actions is modified to initiate only communications by email. In another example, if the results of previous communications indicate that the prospective customer prefers to be contacted the following month, the schedule of actions is modified cease communications until next month when a communication will be initiated.

In step 316, it is determined whether there is another communication to send customer 110 according to the schedule of actions generated in step 208. If so, then in step 318 the next communication is sent according to the schedule and control flows back to step 304. Otherwise, the control flow of FIG. 3 ceases.

The present invention can be realized in hardware, software, or a combination of hardware and software in the system described in the figures above. A system according to a preferred embodiment of the present invention can be realized in a centralized fashion in one computer system or in a distributed fashion where different elements are spread across several interconnected computer systems. Any kind of computer system—or other apparatus adapted for carrying out the methods described herein—is suited. A typical combination of hardware and software could be a general-purpose computer system with a computer program that, when being loaded and executed, controls the computer system such that it carries out the methods described herein.

An embodiment of the present invention can also be embedded in a computer program product, which comprises all the features enabling the implementation of the methods described herein, and which—when loaded in a computer system—is able to carry out these methods. Computer program means or computer program as used in the present invention indicates any expression, in any language, code or notation, of a set of instructions intended to cause a system having an information processing capability to perform a particular function either directly or after either or both of the following: a) conversion to another language, code or, notation; and b) reproduction in a different material form.

A computer system may include, inter alia, one or more computers and at least a computer readable medium, allowing a computer system, to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer readable medium may include, for example, volatile storage such as RAM, buffers, cache memory, and network circuits.

In this document, the terms “computer program medium,” “computer usable medium,” and “computer readable medium” are used to generally refer to media such as main memory removable storage drive, a hard disk installed in hard disk drive, and signals. These computer program products are means for providing software to the computer system. The computer readable medium allows the computer system to read data, instructions, messages or message packets, and other computer readable information from the computer readable medium. The computer readable medium, for example, may include non-volatile memory, such as Floppy, ROM, Flash memory, Disk drive memory, CD-ROM, and other permanent storage. It is useful, for example, for transporting information, such as data and computer instructions, between computer systems.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

We claim:

1. A method executing on a server for managing prospective customer data over a communications network, comprising:
receiving profile data from a prospective customer at a first terminal at a point-of-sale location;
storing the profile data in a central data repository;
displaying the profile data on a second terminal at the point-of-sale location for viewing by a representative, wherein selected profile data is highlighted for use by the representative in selling to the prospective customer;
generating a schedule of actions pertaining to the prospective customer based on the profile data, wherein an action includes sending a communication to the prospective customer;
transmitting one or more communications to the prospective customer based on the schedule of actions;
receiving updates regarding results of the communications transmitted to the prospective customer; and
augmenting the profile data of the prospective customer in the central repository with the results of the communications transmitted to the prospective customer.

2. The method of claim 1 wherein the first terminal comprises a desktop, laptop, smartphone, tablet PC or interactive kiosk.

3. The method of claim 2 wherein the selected profile data is selected based on an algorithm that identifies data relevant to selling to the prospective customer.

4. The method of claim 3 wherein the schedule of actions further comprises a list of communications to the customer, scheduled to occur at predefined dates.

5. The method of claim 4 wherein the schedule of actions further comprises a list of communications to one or more representatives, scheduled to occur at predefined dates.

6. The method of claim 5 wherein the schedule of actions further comprises a list of communications including at least one of: an email, an automated telephone call, a telephone call with a live representative, and a text message.

7. The method of claim 6 wherein representatives enter, via a graphical user interface, updates regarding results of the communications transmitted to the prospective customer.

8. The method of claim 7 wherein updates refer to any one of: in ability to communicate with the prospective customer, an unsuccessful communication with the prospective customer, a completed sale to the prospective customer, and a request from the prospective customer to communicate at a future time.

9. The method of claim 8 further comprising sending to one or more representatives the updates regarding results of the communications transmitted to the prospective customer.

10. The method of claim 9 further comprising modifying the schedule of actions based on the updates regarding results of the communications transmitted to the prospective customer.

11. A method executing on a server for managing prospective customer data over a communications network, comprising:
receiving profile data from a prospective customer at a first terminal at a point-of-sale location;
storing the profile data in a central data repository;
generating a schedule of actions pertaining to the prospective customer based on the profile data, wherein an action includes sending a communication to the prospective customer;
transmitting one or more communications to the prospective customer based on the schedule of actions;
receiving updates regarding results of the communications transmitted to the prospective customer; and
augmenting the profile data of the prospective customer in the central repository with the results of the communications transmitted to the prospective customer.

12. The method of claim 11 wherein the first terminal comprises a desktop, laptop, smartphone, tablet PC or interactive kiosk.

13. The method of claim 12 wherein the selected profile data is selected based on an algorithm that identifies data relevant to selling to the prospective customer.

14. The method of claim 11 further comprising sending to one or more representatives the updates regarding results of the communications transmitted to the prospective customer.

15. The method of claim 14 further comprising modifying the schedule of actions based on the updates regarding results of the communications transmitted to the prospective customer.

16. A computer system for managing prospective customer data over a communications network, comprising:
an interface for receiving profile data from a prospective customer at a point-of-sale location;
a repository for storing the profile data;
a display for displaying the profile data at the point-of-sale location for viewing by a representative, wherein selected profile data is highlighted for use by the representative in selling to the prospective customer;
a processor configured for generating a schedule of actions pertaining to the prospective customer based on the profile data, wherein an action includes sending a communication to the prospective customer;
a transmitter for transmitting one or more communications to the prospective customer based on the schedule of actions;
an interface for receiving updates regarding results of the communications transmitted to the prospective customer; and
wherein the processor is further configured for augmenting the profile data of the prospective customer in the central repository with the results of the communications transmitted to the prospective customer.

17. The computer system of claim 16 wherein the interface for receiving profile data comprises a desktop, laptop, smartphone, tablet PC or interactive kiosk.

18. The computer system of claim 17 wherein the selected profile data is selected based on an algorithm that identifies data relevant to selling to the prospective customer.

19. The computer system of claim 18 wherein the transmitter is further configured for sending to one or more representatives the updates regarding results of the communications transmitted to the prospective customer.

20. The computer system of claim 19 wherein the processor is further configured for modifying the schedule of actions based on the updates regarding results of the communications transmitted to the prospective customer.
